(19) United States
(12) Patent Application Publication
(10) Pub. No.: US 2003/0137976 A1
(43) Pub. Date: Jul. 24, 2003

(54) Method and apparatus for IP based metered service on demands network

(76) Inventors: Yanong Zhu, Scotts Valley, CA (US); Jianxun Ai, Shanghai (CN); Jin Xu, Shanghai (CN); Guonian Zhao, Shanghai (CN); Gang Deng, Shanghai (CN); Xuefei Han, Shanghai (CN)

Correspondence Address: Yanong Zhu, 5619 Scotts Valley Dr. #210, Scotts Valley, CA, 95066, US

(21) Appl. No.: 10/309,452

(22) Filed: Dec. 3, 2002

Related U.S. Application Data
(60) Provisional application No. 60/349,414, filed on Jan. 22, 2002.

(51) Int. Cl. H04L 12/66

(52) U.S. Cl. 370/354

(57) ABSTRACT

A method and apparatus are disclosed for building a unified network for providing voice, video, and data based on metered service on demands and IP. The unified network comprises a first network for broadband secure common channel signaling, a second network for subscriber communications and nodes of routing and switching apparatus for processing subscriber traffic, keeping subscriber information and billings. The broadband secure common channel signaling network can rout, forward, process the subscriber network signaling. The subscriber network transmits subscriber communication traffic. The nodes of routing switching apparatus process the subscriber communication data following instructions from the subscribers, the signaling network and the routing protocols. The service on demands requests are processed by the routing switching apparatus, transmitted to and processed by the signaling network. The signaling network sends instructions to routing switching apparatus for packet routing, packet stream switching, QoS controlling, mobile user supporting, and certificate authenticating functions. The metering system meters the usages of the resources and various services for each subscriber. The metering system produces and records the detailed usage information that can be used for customer billing for either online or offline processing.

### BACKGROUND OF THE INVENTION

1. Field of the Invention

The present invention generally relates to digital broadband unified telecommunication network based on Internet Protocol (IP) and more particularly to common channel signaling network based on Virtual Private Network (VPN) for providing metered service on demands, in addition to providing traditional Internet services for subscribers.

2. Description of Prior Art

In order to both enable service providers to become more profitable and offer consumers services with higher speed, better quality and less cost, public telecom network operators must move beyond the limitations of the broadband Internet's current subscription model which, emerged as a byproduct of the Internet's roots, by enhancing the broadband infrastructure to include metered service on demand functionality. Regardless of the bandwidth available, only with the metered service functionality can the broadband network's limited resources be efficiently used, and only the metered service business model can successfully meet the current needs and realize the future possibilities of the intelligent network.

In the current subscription model, sending data next door costs the same as sending it across the globe, and general users who are shopping, sending email, and reading news pay the same as professional and corporative users who use the network resources thousands of times. The subscription model, with its resulting cost structure and limited utility, has dramatic impact on the broadband market. Broadband penetration in the consumer market has been limited by high monthly subscription charges, which are substantially higher than that of a telephone line, even though the broadband and traditional telephone networks have similar access segment capital cost.

History shows just how efficiently metered services use limited network resources. Traditional telephone services have, with only a few thousand circuits between cities, been able to deliver high quality and long distance telephone services to the general public. Today, the Tera-bit Internet backbone has the capacity to setup millions of broadband circuits for delivering real-time and high-resolution video, yet no such services are available. Other metered service examples include public utilities such as electricity and water, which also provide available usage of resources.

The ability of traditional telephone network operators to efficiently manage resources has not only resulted in lower monthly charges for general users, but also enabled operators to realize higher profit margins. Proof of this can be seen in the fact that, although voice revenues are declining in the face of a changing competitive landscape, they are still the cash cow of the telecommunication industry. In contrast, very few subscription based broadband Internet operators are profitable. With the current subscription model, in fact, it is nearly impossible for broadband Internet operators to become profitable.

To understand the limitations of today's Internet, one must understand the network's cold war roots. It's architecture-constructed as a layer above the traditional telephone network was originally designed to ensure that defense data could still be transported if the network was partially destroyed. Each Internet node forwards data based on the “best effort forwarding” principle, built on the assumption that a link between two end points could have many potential routes. Routing tables learn these routes through routing protocols and automatically determine the best port from which to forward data packets at each node. When this architecture was designed, there was no intention of developing it into a public global transmission system. Under the best effort principle, the Internet is incapable of providing metered services because it can't understand the routes taken and resources needed for each task, nor can it reserve resources effectively in the way that the telephone does. Not only does today's Internet suffer the repercussions of best effort forwarding, it also hasn't been designed, as the telephone network was, for massive deployment in which individual nodes must serve over 100,000 users, a design flaw that substantially limits its ability to dynamically and efficiently cope with a massive user base and makes it unsuitable as a public communication network.

Because of the desire to take the advantages of both Internet and traditional PSTN technologies, there is a need in the art for systems and methods for maintaining “best effort forwarding” and additionally providing service on demands for effectively managing network resources.

### BRIEF SUMMARY OF THE INVENTION

The foregoing needs and objects, and other needs and objects that will become apparent from the following description, are fulfilled by the present invention, which comprises two logically networks and routing switching apparatus, one network for broadband secure common signaling, and the other network for subscriber communications. The routing switching apparatus provide for packet routing, packet stream switching, QoS controlling, bandwidth managing, and certificate authenticating.

The signaling system performs essential functions for the metered service on demand broadband network. The signaling system determines the privileges of the subscribers, the capability of the network related to the subscribers, the resources needed and available resources needed to accomplish the service requests, then enable the billing processes. This signaling system also enables the network to balance the use of limited network resources so that it can meet user's needs efficiently.

The broadband secure common channel signaling network can be either VPN or separated physical network. When the signaling network and subscriber communication network share the same physical media, the signaling network packets have the highest priorities for routing and processing.

Each subscriber has a unique digital certificate. When the subscriber connects the network and makes requests for service, he/she sends access requests along with the subscriber's information with digital signature through a security link to the routing switching apparatus. If the subscriber has registered in Home Location Register (HLR) of the routing switching apparatus and has the privileges, the requests will be granted. If the subscriber is not local and makes the requests at a remote location, the signaling network will send his/her Visitor Location Register (VLR) address information to his/her HLR and store a pointer in the HLR for his/her VLR location to check the authentication and ask for his/her privilege information and then send authorization instructions and messages to the VLR. Using the VLR information, the remote routing switching apparatus can provide services for meeting the demands of the subscriber.

The authentication information always stays in HLR for security reason. When the subscriber moves to another remote routing switching apparatus, the pointer in the HLR will be updated to follow the move.

To contact the subscriber, the request of contact will be first checked in the HLR. Following the pointer to remote VLR, the caller's request will also be forwarded to the remote VLR and processed there. The billing information in the VLR and HLR are synchronized via the broadband secure common channel signaling network.

An executable program resides in the subscriber's terminal and maintains the secure link with the routing switching apparatus and to the signaling network for user signaling. Any service on demands and signaling between the signaling network and subscriber will go through the program. The program also maintains all digital certificates for the service on demands network and provides link status and usage monitoring.

The messages that pass the interface between the signaling network and subscriber communication network follows the pre-configured formats and grammars to avoid security risk.

The new architecture is filly compatible with current Internet's TCP/IP and routing protocols. It solves the key security issue in future network for certificate authentication. It is also designed for broadband mobile network.

By combining the signaling network and the routing switching service apparatus, the new generation of the broadband Internet becomes very powerful. On the one hand, it supports all existing Internet features; on the other, it supports metered services and efficient network management. The metered architecture enables many new applications. With it a user can request a broadband circuit between two (or among several) locations capable of running applications such as high-resolution videophones, videoconference, and high quality voice communications and other real-time communications. The resulting broadband circuit matches the user's bandwidth needs and runs their application with guaranteed quality of service.

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following detailed description taken in conjunction with the accompanying drawings, in which:

FIG. 1 illustrates a metered service on demands network architecture. The real line represents the physical connections and the dot lines can be either physical connection or VPN.

FIG. 2 illustrates a network for common channel signaling.

FIG. 3 illustrates, if the signaling network is virtual, the physical connections between Internet network and Broadband Secure Common Channel Signaling Signal Points (BS-SPs), and Broadband Secure Common Channel Signaling Signal Transfer Points (BS-STPs).

FIG. 4 illustrates the connections between routing switching apparatus for BS-SP, broadband secure common channel signaling and subscriber communication network.

FIG. 5 illustrates connections between Resource Database (RDB) routing switching core, HLR/VLR and BS-SP.

### DETAILED DESCRIPTION OF THE INVENTION

For the traditional Internet “best effort” method, traffic are processed by subscriber network alone without signaling network, except for the situations in which the access rights needs to be granted. The routing tables are upgraded through the routing protocols. The subscribers receive services based on the best effort of the network upon the availability of the resources. In this present invention, services in a metered service on demands network are designed to be fully compatible with the current Internet services.

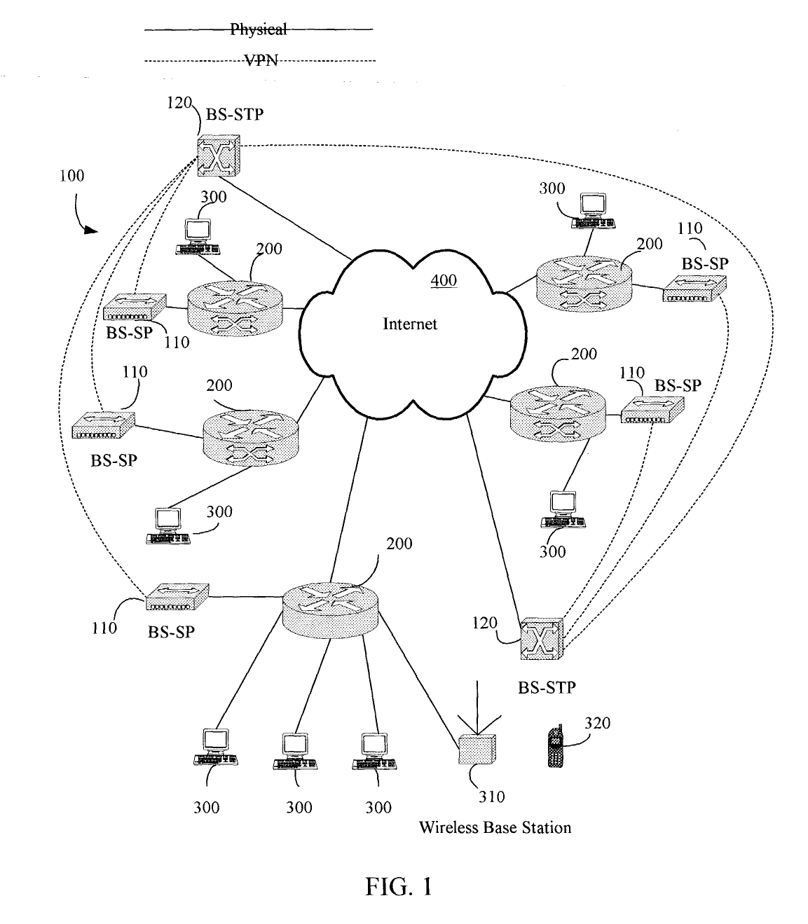

With reference to FIG. 1, illustrated is the network system for metered service on demand comprising two sub-networks, which are broadband secure common channel signaling network 100 and subscriber network for subscriber communication, and routing switching apparatus 200 associated with said two sub-networks, being coupled to subscriber's terminals 300 for routing and forwarding IP traffic following instructions from the signaling network 100.

The two sub-networks can be physically separated networks or be in the same physical network but logically separated through VPN. When the two sub-network share the same physical media, the transmission of instructions and messages are at the highest priorities.

The signaling network 100 comprises a plurality of Broadband Secure Signal Points (BS-SPs) 110 for processing signaling messages and a plurality of broadband secure Signal Transfer Points (BS-STPs) 120 for connecting the BS-SPs 110. Network traffic between BS-SPs 110 can be routed via a packet switch called a STP 120. The STP 120 routes each incoming message to an outgoing signaling link based on routing information contained in the signaling network 100. Because it acts as a network hub, the STP 120 provides improved utilization of the signaling network 100 by eliminating the need for direct links between all SPs 110.

As shown in FIG. 1, the signaling network 100 is critical to metered service on demands. The signaling network 100 determines the privileges of the subscribers, the capability of the network related to the subscribers, the resources needed and available resources needed to complete the service request, then enables the billing process. The signaling system 100 also enables the network to balance the use of limited network resource for meeting the subscriber's need efficiently.

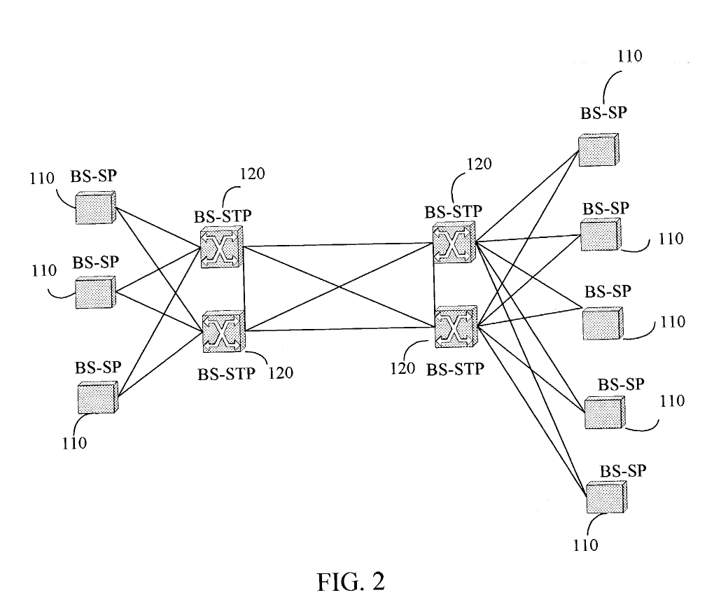

Referring to FIG. 2, illustrated is the broadband secure common channel signaling network 110, comprising the BS-SPs 110 and BS-STPs 120. Each pair of the BS-STP 120 forms a redundancy STP 120. Each BS-SP 110 connects to two BS-STPs 120 for redundancy. The four BS-STPs 120 are crossing connected each other for linking redundancy. The links showed in FIG. 2 can be either physical or virtual.

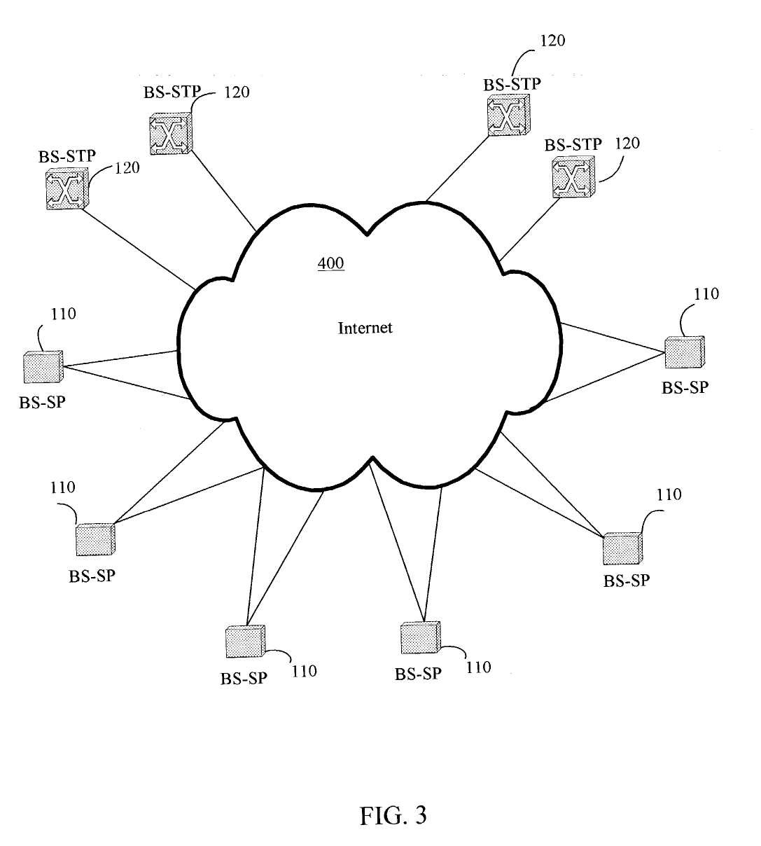

FIG. 3 illustrates, if the signaling network 100 is virtual, the physical connection between Internet 400, BS-SPs 110 and BS-STPs 120. Each BS-STP 120 is coupled to the Internet 400 for routing network traffic via the Internet 400 to the BS-SP 110 which is connected to the Internet 400 as well. Each BS-SP has an indirect link with each other via the Internet 400 and the BS-STP 120.

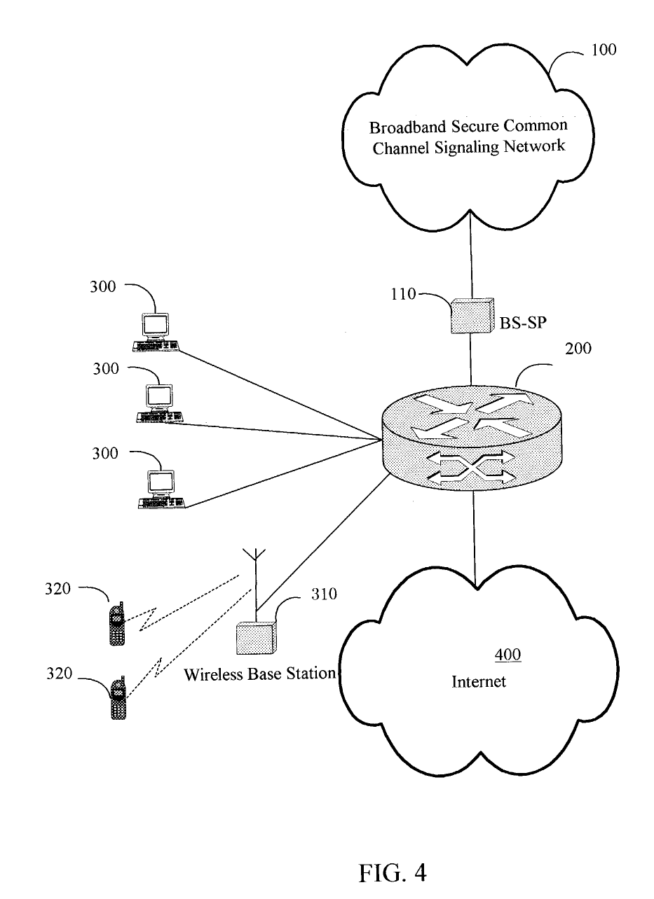

Turning now to FIG. 4, illustrated is connections between the routing switching apparatus 200, BS-SP 110, subscriber communication network, and broadband secure common channel signaling network 100. The subscriber communication network includes the terminals 300 and wireless telecommunications network including at least one wireless base station 310 for transmitting signal to subscriber's mobile device 320. Each routing switching node 200 connects to the signaling network 100 through the BS-SP 110.

A subscriber can have his/her IP address from a pre-assignment of static IP address or automatically assigned dynamic IP address. The static IP address has to be assigned associated with the physical address and will not support mobile services. The dynamic IP address is automatically assigned each time when the subscriber connected to network, and is designed to support mobile services.

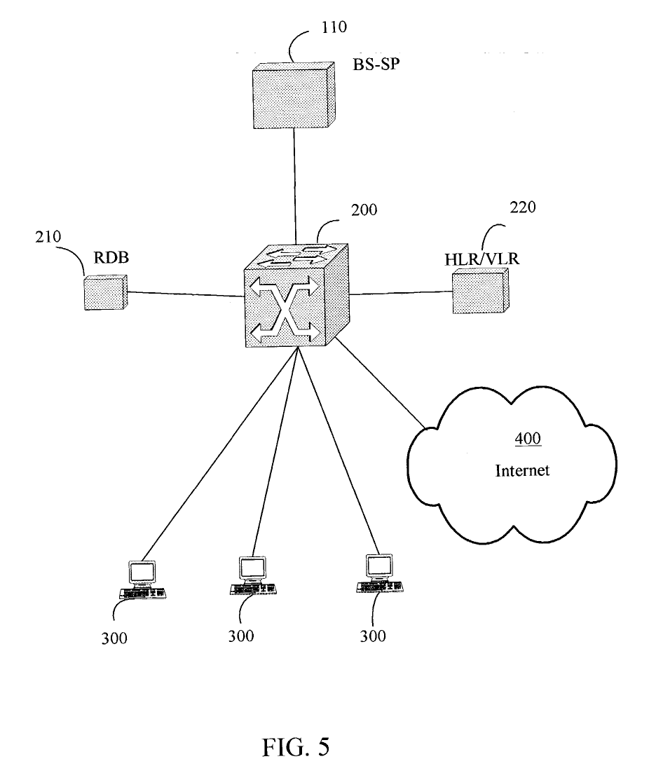

Finally FIG. 5 illustrates the detailed connections between the routing switching apparatus 200, the Internet 400 and BS-SP 110. The routing switching apparatus 200 comprises a resource database (RDB) 210 which, is the core of the routing switching apparatus 200 for management of resources and status. Home Location Register (HLR) 220 is used for subscribers registered in this node and Visitor Location Register (VLR) 220 for visitors from other nodes.

If a subscriber wants to setup a call, he/she sends access requests along with his/her digital signature through a security link to the routing switching apparatus 200 in format of IP packet, which is in packet encapsulation with head information encryptions, the digital signature processed by the BS-SP 110 of the signaling network 100. After his/her identity and privileges are established, the signaling network 100 and routing switching node 200 will process his/her request. If the requests can be met, the signaling network 100 will return a signal to the requester and tell him that the service is ready. If the requests cannot be met, the signaling system will return a signal to the requester and tell him that the requests cannot be granted and the reasons why it cannot be granted.

For the metered service on demand network, Each subscriber's terminal 300 includes an executable program resides therein which, maintains secure link physically to the routing switching apparatus 200 and logically to the signaling network 100 for user signaling. The program provides all digital certificates for the service on demands network and provides for link status and usage monitoring and the service on demands and signaling between the signaling network 100 and subscriber will go through it.

After the subscriber connects his/her terminal 300 to the network, the subscriber signaling module will first establish a secure link and send his/her information along with his/her digital signature to the routing switching apparatus 200. The routing switching apparatus 200 checks whether the subscriber is local or remote. If the subscriber is local, the information will be processed in the local HLR 220, if the subscriber makes the requests at remote location, the broadband secure signaling network 100 will send his/her VLR address information to his/her HLR 220 and store a pointer in HLR for his/her VLR location. After the authentication is passed, the HLR 220 will transmit the subscriber's privilege information to the subscriber's VLR 220 through the broadband secure signaling network 100. After the remote verification, his/her information required for the roaming will be returned to current node for services establishments.

Then the subscriber transmits his/her location service capability parameters to the HLR 220 or VLR 220, the parameters including the following functions: forwarding Internet traffic, switching connection orientated IP traffic, performing QoS functions, controlling bandwidth and other processing, subscriber access controlling, and tracking usages. The routing switching apparatus 200 processes secure link protocols, such as IPSEC, SSL and so on, and then processes, routes and forwards encrypted instruction and messages. Based on the digital certification, the routing switching apparatus 200 transmits messages from the HLR 220 to the signaling network 100 for establishing the subscriber service privilege classes. The signaling network 100 processes subscriber-active protocol, such as RADIUS, AAA and so on, and allocate network resources messages requested from the subscriber. Then the routing switching apparatus 200 allocates resources messages following the subscriber-active protocol. Therefore, a call of metered service on demand is setup.

When a subscriber demands his/her traffic to be treated with higher priorities, he/she will send instruction through the signaling module in his/her terminal 300 to the routing switching node 200 which he/she has connected, if the process involves more than one routing switching node 200, the signaling network 100 will send requesting messages to related nodes as well, until all related nodes agree to provide the requested services, the subscriber will be acknowledged for the success or fail of the setup. If the subscriber's demands cannot be met, the node connected will send out a cancel signal through the signaling network 100 to other nodes to cancel the requests.

When a subscriber demands a guaranteed bandwidth, his/her request will be first sent to the routing switching node 200 that he/she is connecting. If the request associated with resources is managed by other routing witching nodes 200, the request will also be forwarded to them, until all the related nodes receive the messages and grant the requests through the signaling network 100, all related nodes returned messages for request will be sent back to the subscriber directly connected node and then relay to his/her terminal 300. If the subscriber's demands cannot be met, the direct connecting node will send out a cancel signal through the signaling network 100 to other related nodes to cancel the request.

When a subscriber demands a circuit with a set of QoS parameters, the signaling network 100 will coordinates the related nodes on step-by-step mode until the destination node and terminal have been reached. Any failure during the process will be returned with a failure massage or status explaining why the demands cannot be met. If the subscriber's demands cannot be met, the node he/she is connecting will send out a cancel signal through the signaling network 100 to cancel the request.

When a subscriber calls other subscriber through the metered service on demands network, the process is similar as for setting up a QoS circuit, except that more called party signal may involved, such as refuse of connections, deny accesses, unable to allocate resources for the access loop, forced password failure, etc.

For wireless subscribers, when the subscriber roams from one cell to another, he/her will have two wireless link channels, one for current cell and another for the new cell. The signal having stronger strength will be used for communications. Then the wireless base station 310 will transmit wireless ready to handle signals, and the subscriber transmit request to locate messages. After that, the routing switching apparatus 200 will process information in HLR and/or VLR. The packets sequence and control are performed in the subscriber's terminal 300 at layer 3 and above.

When a subscriber connects to the network, his/her access parameters will be sent to the routing switching apparatus 200 and saved in the RDB 210. The information in the RDB 210 will be used in the case when he/she is making a request or he/she is been called for services. If the resources demanded are more than the available resources, the routing switching apparatus 200 will return a signal for failure and type of the failure.

The network resource used by each subscriber is managed by the RDB 210 of the routing switching nodes 200, and records kept in the HLR 220 database. If the visiting node does not belong to the same operating company, his/her VLR data or registered ID number will be recorded for inter carrier-billing purpose.

When a subscriber roams from one routing switching apparatus node 200 to another, the VLR 220 information will be sent back to his/her HLR 220 for synchronization. Each routing switching apparatus 200 can be configured as to save the VLR into billing database or save only the VLR ID for the visit.

The present invention provides significant advantages to communications systems, in general, and the invention is particularly advantageous to the metered service on demands based on IP network. Although the principles of the present invention have been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention be defined by the claims appended hereto, and their equivalents.

What is claimed is:

1. A method for transmitting and routing instructions and messages over a secured virtual private common channel signaling network based on Internet Protocol (IP) that is coupled to at least one routing switching apparatus and at least one subscriber's terminal to meet the metered service on demand, comprising the steps of:
the subscriber transmitting encrypted sign-on information with digital signature in format of IP packets to the routing switching apparatus;
if the subscriber is local, the signaling network processing the sign-on information with digital signature in comparison with information which is stored in home location register (HLR) database of routing switching apparatus, and establishing service right and identity of the subscriber by the comparison;
if the subscriber is roaming, the signaling network transmitting messages to the subscriber's HLR for comparison, if the authorization is passed, establishing service right and identity of the subscriber by processing information in subscriber's Visitor Location Register (VLR);
the subscriber transmitting new location service capability parameters of the subscriber to the HLR database or the VLR database, the parameters including the following functions: forwarding Internet traffic, switching connection orientated IP traffic, performing Quality of Service (QoS) functions, bandwidth control, subscriber access control, and tracking usages;
the routing switching apparatus processing secure link protocol;
the routing switching apparatus processing, routing and forwarding encrypted instruction and messages;
the routing switching apparatus transmitting messages from the HLR to the signaling network for establishing the subscriber service privilege classes based on the digital certification;
the signaling network processing subscriber-active protocol;
the signaling network allocating network resources messages requested from subscribers; and
the routing switching apparatus allocating resource messages from subscriber-active protocol, whereby a call of metered service on demand is setup.

2. The method in accordance with claim 1, wherein in the step of transmitting encrypted sign-on information, the packets are transmitted with head information encryptions.

3. The method in accordance with claim 1, wherein in the step of transmitting encrypted sign-on information, the packets are transmitted in packet encapsulation.

4. The method in accordance with claim 1, wherein said steps of processing request are performed on automatically assigned IP address.

5. The method in accordance with claim 1, wherein said steps of processing examine the contents of the instructions and messages follows pre-configured format and grammars.

6. The method in accordance with claim 1, wherein said steps of the signaling network transmitting messages and instructions are performed by Signal Points (SPs) and Signal Transfer Points (STPs) of said signaling network.

7. The method in accordance with claim 6, wherein the SPs and STPs are coupled physically or by Virtual Private Network (VPN).

8. The method in accordance with claim 1, wherein said routing switching apparatus further comprises a Resource Database (RDB).

9. The method in accordance with claim 1, wherein the secure link protocol implements an IPSEC standard.

10. The method in accordance with claim 1, wherein the secure link protocol implements a SSL standard.

11. The method in accordance with claim 1, wherein the subscriber-active protocol follows a RADIUS standard.

12. The method in accordance with claim 1, wherein the subscriber-active protocol follows an AAA standard.

13. The method in accordance with claim 1, wherein in the step of the routing switching apparatus processing, routing and forwarding encrypted instruction and messages further comprising the steps of:
the subscriber transmitting access requests for enabling access to the network;
the subscriber transmitting bandwidth request and parameters for bandwidth demands of access to the network;
the subscriber transmitting QoS requests and parameters for setting priority, delay, jitter, and packet loss rate services to the network;
the subscriber transmitting QoS circuit request and parameters for setting up a circuit between two peer points to the network;
the subscriber transmitting security setup parameters to the network;
the subscriber transmitting static route setup requests for security concerns to the network;
the network transmitting resource usage information to subscribers; and
the routing switching apparatus transmitting communication status between the network and subscriber.

14. The method in accordance with claim 1, if the subscriber's terminal is a mobile device, further carrying out the steps of:
transmitting wireless signal strength status;
transmitting wireless channel to handle signals;
transmitting wireless ready to handle signals;
transmitting request to locate subscriber messages; and
processing information in HLR and VLR.

15. The method in accordance with claim 1, wherein in the subscriber's terminal resides an executable program which maintains secure link physically to the routing switching apparatus and logically to the signaling network for user signaling.

16. A network system for metered service on demands based on Internet Protocol (IP), comprising:
a first IP sub-network for broadband secure common channel signaling, which routes, forwards and processes subscriber and network signaling, comprising a plurality of signal points (SPs) for processing signaling messages and a plurality of broadband secure Signal Transfer Points (BS-STPs) connecting said BS-SPs for exchanging messages between the BS-SPs, linked to;
a second IP sub-network for subscriber communications; and
at least one IP routing switching apparatus associated with said two networks coupled to subscriber's terminals for routing and forwarding IP traffic according to instructions from the first IP sub-network.

17. The network system in accordance with claim 16, wherein said two sub-network share the same physical media through Virtual Private Network (VPN), by which the instructions and messages are transmitted at the highest priorities.

18. The network system in accordance with claim 16, wherein the BS-STPs and BS-TPs are coupled physically or by VPN.

19. The network system in accordance with claim 16, wherein the routing switching apparatus comprises Home Location Register (HLR) and Visitor Location Register (VLR).

20. The network system in accordance with claim 16, wherein the routing switching apparatus further comprises a Resource Database (RDB).
